(19) United States
(12) Patent Application Publication
(10) Pub. No.: US 2006/0121174 A1
(43) Pub. Date: Jun. 8, 2006

(54) Compositions and methods to deliver consumable water dispersible phytosterols

(76) Inventor: William Conrad Franke, Cranbury, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/274,075

(22) Filed: Nov. 15, 2005

Related U.S. Application Data
(60) Provisional application No. 60/634,140, filed on Dec. 8, 2004.

(51) Int. Cl. A23D 9/00

(52) U.S. Cl. 426/611

(57) ABSTRACT

The present invention describes compositions and methods containing water-dispersible phytosterol esters useful in the reduction of serum cholesterol when consumed as part of a heart healthy diet. The compositions and methods can be used to incorporate phytosterol esters into aqueous based dry foods and beverages that are extracted or reconstituted with hot water. The composition comprises a mixture of phytosterol esters, a surfactant and optionally an oil soluble antioxidant and needs no prior emulsification, homogenization or drying to render the phytosterol esters water dispersible in the recommended food applications.

### CROSS REFERENCE TO RELATED APPLICATION

This application claims the benefit of U.S. Provisional Patent Application Ser. No. 60/634,140, filed Dec. 8, 2004, and entitled Compositions and Methods to Deliver Consumable Water Dispersible Phytosterols, the entire disclosure of which is incorporated herein by reference.

### FIELD OF THE INVENTION

The present invention relates to the formulation and delivery of phytosterol esters. More specifically, it relates to water dispersible formulations of sterol esters that are useful in the reduction of serum cholesterol when consumed as part of a heart healthy diet. The composition comprises a mixture of phytosterol esters, a surfactant and optionally an oil soluble antioxidant and needs no prior emulsification, homogenization or drying to render the phytosterol esters water dispersible in the recommended food applications.

### BACKGROUND OF THE INVENTION

Coronary heart disease (CHD) is a common and serious form of cardiovascular disease that causes more deaths in the U.S. every year than any other disease. High serum cholesterol, and especially high levels of low density lipoprotein (LDL) cholesterol, are risk factors associated with CHD. Research has shown that esters of plant sterols or stanols (i.e., sterol esters) may lower total and LDL cholesterol and thereby reduce the risk of CHD.

Phytosterols are plant sterols structurally similar to cholesterol that have been known for many years to reduce cholesterol absorption and serum cholesterol levels while not being absorbed themselves. Lowering of circulating cholesterol and low density lipoprotein cholesterol is an important part of a strategy to prevent and treat cardiovascular disease and especially coronary heart disease. Cholesterol absorption is a critical component of whole body cholesterol metabolism. Cholesterol derived from the diet and also from endogenous biliary secretion enters the intestine, and approximately 50% of the mixed intestinal load is absorbed. Bosner, M. S., Ostlund, R. E., Jr., Osofisan, O., Grosklos, J., Fritschle, C., Lange, L. G., “Assessment of per cent cholesterol absorption in humans with stable isotopes,” J Lipid Res. 34(6): 1047-53 (1993).

Since phytosterols are natural, non-toxic products that are byproducts of food processing, they may be important in the treatment of individuals with mildly-increased serum cholesterol, or for use by the general population in food products or dietary supplements to reduce the risk of CHD. The use of phytosterols could reduce the need for systematically-absorbed drugs otherwise used for this purpose.

Phytosterols are very difficult to incorporate into products because of their waxy nature. They exhibit high melting points and are insoluble in water. Esterification of phytosterols with fatty acid from vegetable oil renders phytosterols more user friendly and allows their incorporation into high fat products such as margarine and salad dressing. But because they are water insoluble, they still are not suitable for aqueous food systems. Recently, combinations of water dispersible phytosterol-sucrose ester and phytosterol/emulsifier/thickener and of phytosterol ester/emulsifier/protein/starch have been developed for use in products that are thick enough to keep the phytosterols suspended. Some of these combination products require high shear homogenization to disperse (emulsify) the phytosterols. Those suitable for dry applications are formulated and processed similar to artificial creamers. These combination products require the addition of protein, emulsifiers, stabilizers, buffers, and the like to the combination, which is then homogenized and spray- or freeze-dried.

U.S. Pat. No. 5,244,887 relates to a food additive composition containing stanols, including sitostanol to reduce cholesterol absorption. The composition is prepared by dissolving a stenol or mixtures thereof with an edible solubilizing agent (such as triglycerides, vegetable oils, alcohols and polyols), an antioxidant (such as tocopherol), and a dispersant (such as lecithin, other phospholipids, fatty acids and their salts and esters, sodium lauryl sulfate and other detergent-like molecules)

U.S. Pat. No. 5,932,562 relates to a composition for inhibiting cholesterol absorption in humans containing a plant sterol, preferably sitostanol, dispersed in a phospholipid, preferably lecithin. U.S. Pat. No. 6,063,776 relates to a composition for inhibiting cholesterol absorption in humans containing phytosterols, preferably sitostanol, dispersed in an aqueous base emulsifier, preferably sodium stearoyl 2-lactylate (SSL). Either composition can be used in liquid or in dry form. A dry, finely divided water soluble powder is prepared by preparing a phytosterol/emulsifier emulsion via high shear mixing and then drying the aqueous vesicular complex.

U.S. Pat. No. 6,677,327 relates to an edible composition containing an aqueous mixture of phytosterols or phytostanols, a water soluble or water-dispersible protein (such as whey protein, whey powder, soy protein), and, optionally, a low HLB emulsifier. The composition is heated, homogenized and used as an ingredient in liquid systems or dried to provide a powder that is used as an ingredient in the manufacture of another food product, as an additive in food products or alone as a functional food.

U.S. Pat No. 6,623,780 relates to a composition and method to provide a water dispersible sterol product comprising a sterol, a monoglyceride and a polysorbate. These ingredients are combined, heated, rapidly cooled, mixed with water or an aqueous food, heated above the melting temperature of the matrix, and mixed with high shear above the melting point of the mixture.

U.S. Pat. No. 6,787,151 relates to ingestible products for lowering blood total cholesterol, including isoflavone, vegetable protein such as soy protein and phytosterol. The combination of phytosterol with soy protein (which includes isoflavone) is superior to the individual components alone in improving plasma lipid profiles. Preferably the products are food products. Examples of preferred food products according to the invention are margarines or other spreads of oil based products, bakery products, dairy products, e.g. yogurt, cheese and milk-based drinks, beverages, e.g., soft drinks, fruit juices and tea and coffee based drinks, sauces, dressings and mayonnaise and confectionery products, e.g., frozen confectionery products such as water-ice or ice-cream. Especially preferred is the use in food products selected from the group of margarines and other spreads, tea based beverages, dressing and frozen confectionery products.

U.S. published Patent Application No. 2003/0165572 relates to a method for producing water dispersible encapsulated sterols. The method involves creating micelles comprising sterol, starch and a surfactant in an aqueous medium using vigorous agitation and homogenization followed by drying to obtain a water dispersible powder.

U.S. published Patent Application No. 2003/0003131 relates to a process for producing water dispersible sterols by commingling sterols and lecithin in an organic solvent, removing the solvent to produce a commingled solid, grinding the solid to produce a powder, hydrating the powder in water, adding a spray drying adjunct before or after homogenization, and spray drying the homogenized product.

U.S. published Patent Application No. 2004/0013708 relates to water dispersible steryl ester compositions that include steryl esters, an emulsifier and a protein or lipophilic starch. The compositions are prepared by making a melt of the steryl ester and emulsifier, combining the melt with the protein and or starch in an aqueous phase to form an emulsion, homogenizing the emulsion and drying it to form a powder.

U.S. published Patent Application No. 2004/0029844 discloses a method for dispersing plant sterols in aqueous beverages. The method includes the steps of admixing plant sterols and emulsifiers, melting the admixture by heating at 60 to 200 C, and mixing the molten substance with an aqueous beverage at high speed.

U.S. published Patent Application No. 2005/0031761 discloses a functionalized coffee composition comprising one or more non-vitamin, non-mineral functional additives. A coffee composition comprising roast coffee beans (or ground coffee) and phytosterol and/or stanol is described. Corn oil is mentioned as good source of phytosterols and is applied by spray coating or fluid bed treatment. The functionalized beverage is obtained by extraction of the ground coffee comprising a functional additive.

U.S. published Patent Application No. 20050175672 discloses a particulate plant sterol composition having a defined particle size distribution (PSD) characteristics. Processes for preparing the compositions and methods for dispersing the compositions in aqueous media are also provided. The composition consists of plant sterols and does not include an emulsifier. The aqueous media are beverages selected form the group consisting of juice, coffee, tea and others.

It is generally understood that straight phytosterol-sucrose ester combinations rapidly fall out of solution, require constant stirring to re-suspended them, and exhibit a gritty mouth feel.

Individuals can get more esters of sterols or stanols into their diets by consuming fortified or “functional” foods. The FDA has authorized health claims relating to the role of such esters in reducing the risk of coronary heart disease (CHD) for the labeling of specific foods containing these substances. It advises that foods containing at least 0.65 g per serving of plant sterol esters, eaten twice a day with meals for a daily total intake of at least 1.3 g, as part of a diet low in saturated fat and cholesterol, may reduce the risk of heart disease.

Because sterol esters are fat soluble ingredients, they typically have been utilized in fat based foods such as margarines, spreads, salad dressings, and mayonnaise. While this approach facilitates formulating with these ingredients, it is contradictory and confusing to cholesterol-conscious consumers who are trying to reduce the amount of fat in their diets.

There is a need for technology that would permit sterol esters to be used in aqueous systems and to thereby facilitate healthier food choices. The challenge has been to deliver a water dispersible phytosterol composition that does not adversely affect the organoleptic properties of the host food and uniformly deliver an effective dose of phytosterols/phytosterol esters.

Coffee is an excellent beverage vehicle in which to deliver a daily dose of phytosterols. It is widely consumed on a daily basis, is widely available, is relatively inexpensive, and has no calories, carbohydrate or fat. The American Heart Association states “moderate consumption of coffee (1-2 cups per day) doesn't seem to be harmful.” (www.americanheart.org/presenterjhtml?identifier=4445, visited 12/6/04, Healthy Lifestyle; diet and Nutrition; Caffeine; AHA Recommendation.)

A successful method to deliver water dispersible plant sterol or stanol esters in coffee must overcome the following additional challenges: it must uniformly disperse the phytosterol composition in the ground coffee, it must ensure adequate extraction of the phytosterols during brewing, it must prevent the phytosterol composition from becoming trapped in the coffee filter and therefore not delivered to the end user; the phytosterols must stay dispersed and suspended in the brewed coffee long enough for the coffee to be consumed; and the dispersed phytosterols must not be affected by the addition of milk, sugar, creamer or other common additives.

It is an objective of the present invention to provide compositions and methods using water dispersible plant sterol or stanol esters in which it is not necessary to add protein, starches or spray drying adjuncts to make the plant sterols esters water dispersible in commonly consumed food products such as ground coffee (used to make brewed coffee), dried plant material to be “brewed” (e.g., teas, roasted grain beverages) oatmeal, instant soups and other dry mix foods and beverages. The present invention eliminates the need to prepare emulsions via high shear mixing and homogenization, to disperse plant sterols in liquid beverages by milling to specific particle size distributions and homogenizing, or to dehydrate the emulsions/dispersions so prepared for incorporation in dry food.

In addition to preventing the absorption of cholesterol, phytosterols also interfere with the absorption of fat-soluble micronutrients. Since diterpenes are structurally similar to fat-soluble micronutrients, the addition of phytosterols to boiled, cafeteria and Turkish coffee not only would counteract the cholesterol raising effects of these diterpenes but may also prevent their absorption.

The compositions and methods of achieving each of the above objectives, as well as others, will become apparent from the detailed description of the invention that follows hereinafter.

### SUMMARY

The present invention features a unique water dispersible phytosterol composition that can be used to incorporate phytosterol esters into dry food products without incorporating protein, starches or spray drying adjuncts or requiring the preparation of emulsions via high shear mixing and homogenization. In one embodiment of the present invention a composition for reducing serum cholesterol in a mammal, including a human, comprises about 1% to about 99% of at least one plant sterol/stanol ester, and about 1% to about 99% of at least one emulsifying agent, wherein percentages are weight to weight of the composition. In another embodiment, the composition further comprises about 0% to about 0.1% of an oil soluble antioxidant. In another embodiment, the oil-soluble antioxidant of the composition is selected from the group consisting essentially of a tocopherol-derived compound, butylated hydroxyanisole, and a rosemary extract. In another embodiment, the emulsifying agent of the composition is a sucrose ester. In yet another embodiment, the emulsifying agent of the composition is selected from the group consisting essentially of lecithin, stearoyl-2-lactalyate, diacetyl tartaric acid ester of monoglyceride, a polysorbate, a sorbitan fatty acid ester, and a polyglycerol fatty acid ester, alone, or in combination with, a sucrose fatty acid ester. In another embodiment, the sucrose ester of the composition is a sucrose stearate having an HLB of about 16.

In another embodiment of the present invention, a food additive for reducing serum cholesterol in a mammal, including a human, comprises about 1% to about 99% of at least one plant sterol/stanol ester and about 1% to about 99% of at least one emulsifying agent, wherein percentages are weight to weight of the food additive. In another embodiment, The food additive further comprises about 0% to about 0.1% of an oil soluble antioxidant. In another embodiment, the oil-soluble antioxidant of the food additive is selected from the group consisting essentially of a tocopherol-derived compound, butylated hydroxyanisole. and a rosemary extract. In another embodiment, the emulsifying agent of the food additive is a sucrose ester. In another embodiment, the emulsifying agent of the food additive is selected from the group consisting essentially of lecithin, stearoyl-2-lactalyate, diacetyl tartaric acid ester of monoglyceride, a monoglyceride, a polysorbate, a sorbitan fatty acid ester, and a polyglycerol fatty acid ester, alone, or in combination with, a sucrose ester. In yet another embodiment, the sucrose ester of the food additive is a sucrose stearate having an HLB of about 16.

The present invention also provides a food product for reducing serum cholesterol in a mammal, including humans, comprising: (a) about 0.1 to about 50% of a water dispersible plant sterol/stanol ester composition consisting essentially of (i) about 1% to 99% plant sterol/stanol esters and (ii) about 1% to 99% of an emulsifier, and (b) a dry food, wherein percentages are weight to weight of the food product. In another embodiment, the food product provides at least 0.65 g phytosterol esters per serving. In another embodiment, the food product further comprises about 0% to about 0.1% of an oil soluble antioxidant. In another embodiment, the dry food of the food product is a dry beverage. In another embodiment, the dry beverage provides at least 0.65 g phytosterol esters per serving. In another embodiment, the dry beverage is coffee. In another embodiment, about 5% to about 40% of the water dispersible plant sterol/stanol ester composition is combined with about 60% to about 95% ground coffee beans. In another embodiment, the dry beverage of the food product is a hot cocoa mix. In another embodiment, about 1% to about 10% of the water dispersible plant sterol/stanol ester composition is combined with about 90% to about 99% of the hot cocoa mix. In another embodiment, the dry food of the food product is a dry cereal. In another embodiment, about 1% to about 10% of the water dispersible plant sterol/stanol ester composition is combined with about 90% to about 99% rolled oats or precooked oats. In another embodiment, the dry food of the food product is a bakery mix. In another embodiment, the bakery mix is a muffin mix. In another embodiment, about 1% to 10% of the water dispersible plant sterol ester composition is combined with about 90% to 99% of a commercial muffin mix.

The present invention also provides a method of preparing a food composition for reducing serum cholesterol in a mammal, including a human, the method comprising the steps: a) preparing a water-dispersible plant sterol ester composition by (i) combining a plant sterol/stanol ester and an emulsifying agent; (ii) and mixing the plant sterol ester and the emulsifying agent thoroughly to form a paste; (b) combining the paste with a dry food product; and (c) mixing the combined dry food product and the paste thoroughly to uniformly distribute the paste in the food product. In another embodiment, step (b) further comprises the step of combining about 5% to about 40% of the paste with about 60% to about 95% ground coffee beans, wherein percentages are weight to weight of the composition. In another embodiment, step (b) further comprises the step of combining about 1% to about 10% of the paste with about 90% to about 99% of a hot cocoa mix, wherein percentages are weight to weight of the composition. In another embodiment, step (b) further comprises combining about 1% to about 10% of the paste with about 90% to about 99% of rolled oats or precooked oats, wherein percentages are weight to weight of the composition. In another embodiment, the emulsifying agent of the method is selected from the group consisting essentially of lecithin, stearoyl-2-lactalyate, diacetyl tartaric acid ester of monoglyceride, a monoglyceride, a polysorbate, a sorbitan fatty acid ester, and a polyglycerol fatty acid ester, alone, or in combination with, a sucrose ester.

In yet another embodiment of the present invention, a method of preparing a coffee beverage containing a water dispersible plant sterol ester composition comprises the steps of: (a) mixing ground coffee with a plant sterol surfactant mixture to form a coffee-plant sterol-surfactant composition; (b) brewing the coffee-plant sterol-surfactant composition using heated water to form a brewed beverage containing the water dispersible plant sterol ester composition, (c) separating the brewed beverage from the ground coffee by batch or continuous filtering of the brewed beverage through a filtering device; and (d) producing a coffee beverage having at least about 0.65 g phytosterol esters per serving. In another embodiment, the filtering device of step (c) is selected from the group consisting essentially of a filter screen, a perforated basket, a filter, a pod and a teabag. In another embodiment, the filter screen is fabricated from a material selected from the group consisting of a metal wire mesh, a nylon, a polyester, a polypropylene, a polyethylene, and a polyvinyl chloride. In another embodiment, the filter is fabricated from a material selected from the group consisting of a spunbonded polyester, a paper, and a synthetic fiber. In another embodiment, the pod is fabricated from a material selected from the group consisting of a metal wire mesh, a nylon, a polyester, a polypropylene, a polyethylene, and a polyvinyl chloride.

The present invention also provides a method of preparing a coffee beverage for reducing serum cholesterol in a mammal, including a human, containing a water dispersible plant sterol ester composition, the method comprising the steps of: (a) mixing a plant sterol surfactant mixture with whole coffee beans, (b) grinding the plant sterol surfactant coffee bean mixture, and(c) producing the coffee beverage having at least about 0.65 g phytosterol esters per serving.

### DETAILED DESCRIPTION OF THE INVENTION

The present invention features a unique composition that can be used to incorporate phytosterol esters into aqueous based dry foods or beverages. This composition will be referred to as water dispersible phytosterols throughout the application. The water dispersible phytosterols are a mixture of phytosterols esters and sucrose esters that are thoroughly mixed together to form a paste and then dry mixed with dry food and beverage products that are to be either extracted or reconstituted with hot water. The water dispersible phytosterols of this invention do not require preparing melts of ingredients, preparing complex oil in water emulsions, high shear mixing, homogenization or spray drying, although it is possible to form an aqueous emulsion, add drying adjuncts and produce a powder by drying. The water dispersible phytosterols can be mixed with ground coffee and brewed to provide consumers with an easy and inexpensive way to achieve a daily level of sterol esters that will significantly reduce their serum cholesterol. The water dispersible phytosterols can be easily incorporated into many other food products, including, but not limited to, oatmeal, dry soups, teas and hot cocoa mixes.

Phytosterol Ester-Sucrose Ester

Sterol Ester

The term “sterol ester” as used herein means the fatty acid esters of specific plant phytosterols such as: sitosterol, campesterol, stigmasterol, brassicasterol, avenasterols, and diosgenin, or mixtures of specific sterols. Specific sterols or mixtures of sterols may be isolated from the following sources: oilseeds such as soybeans, canola seed, corn, sunflower, cottonseed, palm kernel, corn fiber, soy germ, shea nut, or peanut; tree sources such as tall oil (from pine trees), tall oil soap or tall oil pitch; other plant sources such as Mexican yam, olives, or sugar cane. In oilseeds, the most abundant phytosterols are sitosterol (about 52 to 89% of total sterols), campesterol (about 2 to 30% of total sterols), and stigmasterol (up to 26% of total sterols).

Also included within the definition of “sterol esters” are the esterified and hydrogenated forms of the above mentioned sterols (known in the art as stanols) including but not limited to sitostanol and campestanol. Further included within this definition are sterol ester derivatives such as ferulate esters, or succinate esters.

The fatty acid moiety of the sterol esters can have a carbon chain ranging from about 8 to about 20, with carbon chains of 16 to 18 being particularly useful. Blends of fatty acid moieties having C16 to C18 carbon chains can be isolated from vegetable oils, and in particular, from high oleic acid canola oil, high oleic soybean oil, and high oleic sunflower oil.

The sterol esters described in the present invention are commercially available and well known in the art. Alternatively, sterol esters can be produced from phytosterols, which are typically recovered from deodorizer distillate produced during deodorization or refining of vegetable oils. Individual, purified phytosterols, e.g., purified sitosterol or purified stigmasterol, are available commercially, as are blends of sterols, e.g., soy sterol containing .beta.-sitosterol, stigmasterol, and campesterol and others. Sterols can be obtained as free sterols or as sterol glycosides, in which a sugar moiety is attached to the hydroxyl group of the sterol, or as sterol esters, in which the hydroxyl group is attached to a fatty acid.

Sterol esters can be produced by the process of transesterification, in which the alcohol moiety from a fatty acid ester, e.g., a fatty acid methyl ester, is displaced by another alcohol (in this case, free sterol). Free sterol and a fatty acid methyl ester can be reacted in the presence of base catalysts such as sodium hydroxide or sodium methoxide, an acid catalyst such as p-toluene sulfonic acid, metals such as BBr₃, Me₃SiI, Al₂0₃, Ti(OR)₄, DMAP, and n-BuLi, K t-butoxide, and enzymes such as lipases, esterases, and .alpha.-chymotrypsin. Preferably, the catalyst is food grade. Typically, free sterol is mixed with a molar excess of fatty acid esters (e.g., a 5 to 10% molar excess), and the mixture is heated until the sterols dissolve (approximately 115 to 140.degrees C.) before addition of catalyst. The reaction can be stirred and heated under vacuum until completion, during which time methanol produced from the reaction can be condensed and collected. Alternatively, free sterols and free fatty acids can be directly esterified according to the methods described, for example, in U.S. Pat. No. 5,892,068.

Fatty acid methyl esters can be produced by either,esterifying free fatty acids with methanol or by transesterifying triacylglycerols with methanol. Such reactions can be performed batchwise or continuously. For example, batch transesterification of triacylglycerols with methanol can be performed with an excess of methanol and in the presence of a catalyst, e.g., an alkaline catalyst, under high pressure (9000 kPa) and high temperature (.about.240 degrees C.). See, Bailey's Industrial Oil & Fat Products: General Applications, Vol. 5, pp. 49-53, John Wiley & Sons, Inc., New York, N.Y. (1996). Similar conditions are used for continuous transesterification.

Sterol esters can be purified by solvent or aqueous extraction, bleaching and deodorization, or other known methods. For example, purified sterol esters can be obtained by aqueous extraction by suspending the reaction products in aqueous sodium bicarbonate (e.g., 1%), filtering the suspension to obtain purified sterol esters, and drying the purified sterol esters. Reaction products can be bleached using diatomaceous earth, bleaching clay, activated carbon, silica, or combinations thereof. The purity of sterol esters can be assessed by thin layer chromatography, gas chromatography (GC), or liquid chromatography (LC). LC is particularly useful.

Sucrose Fatty Acid Esters

Sucrose fatty acid esters are nonionic surfactants, i.e., surface-active agents that, when dissolved in water or an aqueous solution, reduce the surface tension of the water or aqueous solution or the interfacial tension between the water or aqueous solution and another liquid. They consist of sucrose as the hydrophilic group and fatty acid as the lipophilic group and are generally referred to as sugar esters. Since sucrose has a total of 8 hydroxyl groups, compounds ranging from sucrose mono to octa esters can be produced.

Sugar esters can have various degrees of esterification. When the kind or number of fatty acid groups are changed, a wide range of hydrophilic-lipophilic balance (“HLB”) values can be obtained.

As used herein, the term hydrophilic-lipid-balance, or HLB, refers to the balance between the hydrophilic (“water-loving”) and lipophilic (“oil-loving”) portions of a molecule. The HLB number indicates the polarity of the molecules in an arbitrary range of 1 (totally lipophilic, or “fat-loving”) to 20 (totally hydrophilic, or “water loving”), with 10 representing an equal balance of both characteristics. For example, polysorbate 80 has an HLB value of 15.4; polysorbate 60 has an HLB value of 14.4; sucrose monostearate has an HLB value of 12.0; diacetyl tartaric ester of monoglyceride (DATEM) has an HLB value of 9.2; sucrose distearate has an HLB value of 8.9; glycerol monostearate has an HLB value of 3.7, and propylene glycol monoester has an HLB value of 1.8.

Sugar esters can have very high HLB values that differentiate them from other food emulsifiers. For example, sucrose stearate S-1670 has an HLB of 16. Particularly useful, for example, are sucrose behenate, sucrose stearate, sucrose oleate, sucrose palmitate, sucrose myristate and sucrose laurate, which are available as Ryoto Sugar esters manufactured by Mitsubishi Chemical Corporation.

The HLB of a blend of two emulsifiers equals the weight fraction of emulsifier A times its HLB value plus the weight fraction of emulsifier B times its HLB value. As used herein, the terms “emulsifier” and “emulsifying agent”, which refer to a substance used to promote the formation and stabilization of an emulsion, and “dispersant” are used interchangeably with the term “surfactant.” An emulsion is a two-phase system prepared by combining two immiscible liquid carriers, one of which is disbursed uniformly throughout the other and consists of globules that have diameters equal to or greater than those of the largest colloidal particles. The globule size is critical and must be such that the system achieves maximum stability. Usually, separation of the two phases will not occur unless a third substance, an emulsifying agent, is incorporated. Thus, a basic emulsion contains at least three components, the two immiscible liquid carriers and the emulsifying agent. Most emulsions incorporate an aqueous phase into a non-aqueous phase (or vice versa). For example, lipophilic emulsifying agents form water-in-oil (w/o) emulsions, while hydrophilic emulsifying agents form oil-in-water (o/w) emulsions. Particularly useful emulsifying agents include, for example, lecithin, stearoyl-2-lactalyate, DATEM, a polysorbate, a sorbitan fatty acid ester, and a polyglycerol fatty acid ester, alone, or in combination with, a sucrose fatty acid ester.

Water Dispersible Phytosterol Ester Compositions

Compositions of the invention include 1 to 99 weight percent sterol ester and 99 to 1 weight percent surfactant (e.g. sucrose ester). These ingredients are food grade, generally recognized as safe (GRAS) or approved food additives. The ratio of sterol ester to surfactant and the total amount of the composition used will be sufficient to deliver at least 0.65 g of sterol esters per serving of the enriched food. Sucrose esters are the preferred surfactant, but lecithin, mono and diglycerides, stearoyl 2-lactalyate, polysorbates, sorbitan fatty acid esters and polyglycerol fatty acid esters and various combinations thereof also can be used.

The significant benefit of this technology is the ability to simply dry mix the appropriate amount of sterol ester-sucrose ester paste with dry food ingredients to yield a free flowing stable food product that can be manufactured and prepared in the same manner as non-enriched products.

Coffee Brewing

Coffee can be brewed in a percolator or drip coffee maker according to well-known methods. If a drip coffee maker is used, a “permanent” wire mesh filter (eg. Swiss Gold, Brew Rite®), a nylon filter, a polyester, polypropylene, polyethylene, PVC, PTFE, or a paper filter designed to allow the sterol esters-sucrose ester to pass through along with the coffee, should be used to deliver an adequate dose of sterol ester. A typical paper coffee filter will allow only partial passage of sterol ester. The width of the openings in the various filter materials can range from approximately 50 to 300 micrometers, the preferred range is 100-200 micrometers to allow passage of the phytosterol esters while still retaining the coffee grinds, especially the fine grounds. It has been discovered that heat seal and non-heat seal paper filters (depth filters such as tea bag paper) having large pores (0.5 to 1.0 mm) and/or high porosity, and/or a low basis weight (less than 40 grams per square meter) and/or treated to be hydrophobic and/or lipophobic will allow significantly greater passage of the phytosterol ester-sucrose ester complex along with the brewed coffee compared to a typical paper filter.

It has also been discovered that a modified paper filter can be employed along with the wire mesh or a nylon filter to capture very small ground coffee particles that some coffee drinkers may find unappealing, and yet this modified filter will permit most of the phytosterols composition to be carried into the brewed coffee. To make such a paper filter, the top 70% of a typical #4 paper filter (is cut off and the remaining bottom third is used as a “cap” to cover the bottom of the wire mesh or nylon filter cone. The capped wire mesh filter is then inserted normally into the plastic support of the coffee maker. The fines and the paper cap are disposed after the coffee is brewed.

The present invention also is ideally suited for the recently introduced “Home Café” single serve type products and coffee bags. A pod or bag made from material that allows the coffee and phytosterol complex to pass yet holds back the coffee grounds is used, such as tea bag paper, nylon, polyester, polypropylene, polyethylene, polyvinyl chloride (“PVC”), and polytetrafluoroethylene (“PTFE”, e.g., Teflon). Alternatively, ground coffee may be loaded directly into the pod pocket of the single serve machines. The built-in metal screen or perforated metal disc retains the grinds yet allows the brewed coffee and phytosterol complex to pass.

Several natural and synthetic food additives are used as antioxidants to help guard against deterioration of food. The term “antioxidant” as used herein refers to substances that prevent chemical oxidation. For example, natural antioxidants include, but are not limited to, tocopherol/vitamin E-derived compounds, ascorbic acid (vitamin C)-derived compounds, and spice extracts, such as those derived from rosemary. Synthetic antioxidants, which in the United States have been evaluated by the Food and Drug Administration, include, but are not limited to, butylated hydroxyanisole (“BHA”), butylated hydroxytoluene (“BHT), and propyl gallate.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural references unless the context clearly dictates otherwise. All technical and scientific terms used herein have the same meaning. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The following examples are put forth to provide those of ordinary skill in the art with a complete disclosure and description of how to make and use the present invention, and are not intended to limit the scope of what the inventors regard as their invention nor are they intended to represent that the experiments below are all or the only experiments performed.

### EXAMPLE 1

### Water Dispersible Sterol Ester

Plant sterol ester (e.g. Cardioaid-S, ADM) is mixed with sucrose ester (e.g. Ryoto S-1670, Mitsubishi-Kagaku Foods) in a ratio ranging from 1:1 to 1:0.1 preferably about 1:0.25. to form a homogenous paste. The mixture may be warmed slightly to about 25-35 degrees C. to facilitate mixing, but it is not necessary. If warmed slightly, the mixture becomes more fluid.

The paste can be mixed with dry foods and beverage mixes to produce free flowing powders or stirred directly into aqueous foods for immediate consumption. The PSE/SE (phytosterol ester/sucrose ester) paste is slowly added to a food substance in the ratio of about 0.5 g to 4.5 g of PSE/SE paste to 5 g to 14 g of the food substance or the appropriate serving of the food to be enriched to deliver at least 0.65 g sterol esters per serving) with continuous mixing to ensure even distribution of the PSE/SE paste and host food. No homogenization or instanizing is required. The plant sterol/sucrose ester paste remains stable during storage and the sterol esters disperse and stay suspended in the freshly prepared foods throughout eating.

### EXAMPLE 2

### “Fresh Ground” Coffee

Approximately nine grams of ground coffee from roasted beans are mixed with 1.25 g of the sterol ester composition prepared as described in Example 1. Decaffeinated, half caffeinated, flavored, or ground beans also can be used. Alternatively, the sterol ester composition can be mixed directly with the whole coffee beans and then the whole coffee bean/sterol ester composition ground.

Procedure

Ground coffee is produced by grinding, for example, Arabica or Robusta coffee beans according to established methods. The sterol ester composition and the ground coffee are thoroughly mixed in a Hobart ribbon, Littleford, Readco continuous mixer or similar mixer to disperse and coat the surfaces of the ground coffee with the sterol-ester composition. Alternatively, the sterol ester mixture is uniformly dispersed over the surface of the whole beans with gentle mixing and then the whole beans are ground normally to produce freshly ground coffee with the sterol ester composition uniformly dispersed throughout the ground coffee.

The sterol ester enriched ground coffee (10.25 g) is brewed with 250 ml water using a Braun Automatic drip coffee maker equipped with a permanent wire mesh filter basket.

The enriched coffee is very similar to the base coffee in flavor, aroma and appearance and delivers at least 0.65 g sterol esters per serving. It can be consumed black, with added sweetener, milk, creamer, or the like.

### EXAMPLE 3

### Fast Roast/High Yield Flaked Coffee

Approximately 6 g of flaked coffee (Folgers) is mixed with 1.25 g of a sterol ester composition prepared as described in Example 1 and brewed as described in Example 2. Decaffeinated, half caf, flavored, coffee enriched with concentrate (used in coffee bags), roasted grains, legumes and roots (e.g. wheat, soy, chicory,) coffees also can be used. Alternatively the sterol ester composition can be added to High Yield Roasted coffee beans prior to flaking or grinding as described in Example 2.

### EXAMPLE 4

### Cafe Latte/Cappuccino

Coffee prepared as described in Examples 2 is whipped in a high-speed kitchen or commercial blender to provide a frothy coffee beverage. Milk, cream or sweetener can be optionally added.

### EXAMPLE 5

### Hot Cocoa

Hot cocoa mix (Swiss Miss) (28 g) is thoroughly mixed with a sterol ester composition (2 g) prepared as described in Example 1. The resulting free flowing powder is placed in a mug. 180 ml of hot water is added and the product gently stirred to dissolve the cocoa mix. The resulting beverage is indistinguishable from the beverage prepared from the starting cocoa mix and provides at least 0.65 g sterol esters per serving

### EXAMPLE 6

### Oatmeal

Two grams of a Sterol Ester composition prepared as described in Example 1 is mixed with 28 grams of Oatmeal (regular or Quick Cooking) by thoroughly dry mixing the oatmeal and sterol esters. The resulting free flowing oatmeal is then prepared normally. The resulting product, which is virtually identical to the non-enriched product in terms of taste, delivers at least 0.65 g of sterol ester per serving.

### EXAMPLE 7

### Dry Soup

Two grams of a sterol ester composition prepared as described in Example 1 are mixed with the seasoning mix or fat plug of a soup mix. The soup is then prepared according to the package directions.

### EXAMPLE 8

### Bakery Mixes

Phytosterol enriched muffins are prepared from 2 grams of a sterol ester composition prepared as described in Example 1 and 38 g of a muffin mix (Jiffy). The sterol ester paste and muffin mix are thoroughly blended together. The enriched muffin mix is relatively free flowing. The muffins prepared from this mix are virtually identical to their non-enriched counter parts. Each muffin delivers at least 0.65 g of sterol ester per serving.

The present invention has been described with reference to the preferred embodiments to illustrate the principles of the invention and not to limit the invention to the particular embodiments illustrated. Modifications and alterations may occur to others upon reading and understanding the preceding detailed description. It is intended that the scope of the invention be construed as including all modifications and alterations that may occur to others upon reading and understanding the preceding detailed description insofar as they come within the scope of the following claims or equivalents thereof.

What is claimed is:

1. A composition for reducing serum cholesterol in a mammal, including a human, comprising about 1% to about 99% of at least one plant sterol/stanol ester, and about 1% to about 99% of at least one emulsifying agent, wherein percentages are weight to weight of the composition.

2. The composition according to claim 1, further comprising about 0% to about 0.1% of an oil soluble antioxidant.

3. The composition according to claim 2, wherein the oil-soluble antioxidant is selected from the group consisting essentially of a tocopherol-derived compound, butylated hydroxyanisole, and a rosemary extract.

4. The composition according to claim 1, wherein the emulsifying agent is a sucrose ester.

5. The composition according to claim 1 wherein the emulsifying agent is selected from the group consisting essentially of lecithin, stearoyl-2-lactalyate, diacetyl tartaric acid ester of monoglyceride, a polysorbate, a sorbitan fatty acid ester, and a polyglycerol fatty acid ester, alone, or in combination with, a sucrose fatty acid ester.

6. The composition according to claim 3, wherein the sucrose ester is a sucrose stearate having an HLB of about 16.

7. A food additive for reducing serum cholesterol in a mammal, including a human, comprising about 1% to about 99% of at least one plant sterol/stanol ester and about 1% to about 99% of at least one emulsifying agent, wherein percentages are weight to weight of the food additive.

8. The food additive according to claim 7, further comprising about 0% to about 0.1% of an oil soluble antioxidant.

9. The food additive according to claim 8, wherein the oil-soluble antioxidant is selected from the group consisting essentially of a tocopherol-derived compound, butylated hydroxyanisole, and a rosemary extract.

10. The food additive according to claim 7, wherein the emulsifying agent is a sucrose ester.

11. The food additive according to claim 7 wherein the emulsifying agent is selected from the group consisting essentially of lecithin, stearoyl-2-lactalyate, diacetyl tartaric acid ester of monoglyceride, a monoglyceride, a polysorbate, a sorbitan fatty acid ester, and a polyglycerol fatty acid ester, alone, or in combination with, a sucrose ester.

12. The food additive according to claim 7, wherein the sucrose ester is a sucrose stearate having an HLB of about 16.

13. A food product for reducing serum cholesterol in a mammal, including humans, comprising:
(a) about 0.1 to about 50% of a water dispersible plant sterol/stanol ester composition consisting essentially of (i) about 1% to 99% plant sterol/stanol esters and (ii) about 1% to 99% of an emulsifier, and
(b) a dry food,
wherein percentages are weight to weight of the food product.

14. The food product according to claim 13, wherein the food product provides at least 0.65 g phytosterol esters per serving.

15. The food product according to claim 13, further comprising about 0% to about 0.1% of an oil soluble antioxidant.

16. The food product according to claim 15, wherein the food product provides at least 0.65 g phytosterol esters per serving.

17. The food product according to claim 13, wherein the dry food is a dry beverage.

18. The food product according to claim 17, wherein the dry beverage provides at least 0.65 g phytosterol esters per serving.

19. The food product according to claim 13, wherein the dry beverage is coffee.

20. The food product according to claim 19, wherein about 5% to about 40% of the water dispersible plant sterol/stanol ester composition is combined with about 60% to about 95% ground coffee beans.

21. The food product according to claim 20, wherein the coffee provides at least 0.65 g phytosterol esters per serving.

22. The food product according to claim 13, wherein the dry beverage is a hot cocoa mix.

23. The food product according to claim 22, wherein about 1% to about 10% of the water dispersible plant sterol/stanol ester composition is combined with about 90% to about 99% of the hot cocoa mix.

24. The food product according to claim 23, wherein the hot cocoa mix provides at least 0.65 g phytosterol esters per serving.

25. The food product according to claim 13, wherein the dry food is a dry cereal.

26. The food product according to claim 25, wherein about 1% to about 10% of the water dispersible plant sterol/stanol ester composition is combined with about 90% to about 99% rolled oats.

27. The food product according to claim 26, wherein the rolled oats provides at least 0.65 g phytosterol esters per serving.

28. The food product according to claim 25, wherein about 1% to about 10% of the water dispersible plant sterol/stanol ester composition is combined with about 90% to about 99% of precooked oats.

29. The food product according to claim 28, wherein the precooked oats provides at least 0.65 g phytosterol esters per serving.

30. The food product according to claim 13, wherein the dry food is a bakery mix.

31. The food product according to claim 30, wherein the bakery mix provides at least 0.65 g phytosterol esters per serving.

32. The food product according to claim 30, wherein the bakery mix is a muffin mix.

33. The food product according to claim 32, wherein about 1% to 10% of the water dispersible plant sterol ester composition is combined with about 90% to 99% of a commercial muffin mix.

34. The food product according to claim 32, wherein the muffin mix provides at least 0.65 g phytosterol esters per serving.

35. A method of preparing a food composition for reducing serum cholesterol in a mammal, including a human, the method comprising the steps:
a) preparing a water-dispersible plant sterol ester composition by
(i) combining a plant sterol/stanol ester and an emulsifying agent;
(ii) and mixing the plant sterol ester and the emulsifying agent thoroughly to form a paste;
(b) combining the paste with a dry food product; and
(c) mixing the combined dry food product and the paste thoroughly to uniformly distribute the paste in the food product.

36. The method according to claim 35, step (b) further comprising the step of combining about 5% to about 40% of the paste with about 60% to about 95% ground coffee beans, wherein percentages are weight to weight of the composition.

37. The method according to claim 35, step (b) further comprising the step of combining about 1% to about 10% of the paste with about 90% to about 99% of a hot cocoa mix, wherein percentages are weight to weight of the composition.

38. The method according to claim 35 step (b) further comprising the step of combining about 1% to about 10% of the paste with about 90% to about 99% of rolled oats, wherein percentages are weight to weight of the composition.

39. The method according to claim 35 step (b) further comprising the step of combining about 1% to 10% of the paste with about 90% to about 99% of precooked oats, wherein percentages are weight to weight of the composition.

40. The method according to claim 35, wherein the emulsifying agent is selected from the group consisting essentially of lecithin, stearoyl-2-lactalyate, diacetyl tartaric acid ester of monoglyceride, a monoglyceride, a polysorbate, a sorbitan fatty acid ester, and a polyglycerol fatty acid ester, alone, or in combination with, a sucrose ester.

41. A method of preparing a coffee beverage containing a water dispersible plant sterol ester composition, the method comprising the steps of:
(a) mixing ground coffee with a plant sterol surfactant mixture to form a coffee-plant sterol-surfactant composition;
(b) brewing the coffee-plant sterol-surfactant composition using heated water to form a brewed beverage containing the water dispersible plant sterol ester composition, and
(c) separating the brewed beverage from the ground coffee by batch or continuous filtering of the brewed beverage through a filtering device; and
(d) producing a coffee beverage having at least about 0.65 g phytosterol esters per serving.

42. The method according to claim 41, wherein the filtering device is selected from the group consisting essentially of a filter screen, a perforated basket, a filter, a pod and a teabag.

43. The method according to claim 42, wherein the filter screen is fabricated from a material selected from the group consisting of a metal wire mesh, a nylon, a polyester, a polypropylene, a polyethylene, and a polyvinyl chloride.

44. The method according to claim 42, wherein the filter is fabricated from a material selected from the group consisting of a spunbonded polyester, a paper, and a synthetic fiber.

45. The method according to claim 42, wherein the pod is fabricated from a material selected from the group consisting of a metal wire mesh, a nylon, a polyester, a polypropylene, a polyethylene, and a polyvinyl chloride.

46. A method of preparing a coffee beverage for reducing serum cholesterol in a mammal, including a human, containing a water dispersible plant sterol ester composition, the method comprising the steps of:
(a) mixing a plant sterol surfactant mixture with whole coffee beans,
(b) grinding the plant sterol surfactant coffee bean mixture, and
(c) producing the coffee beverage having at least about 0.65 g phytosterol esters per serving.
